(19) United States
(12) Patent Application Publication
(10) Pub. No.: US 2008/0085713 A1
(43) Pub. Date: Apr. 10, 2008

(54) Routing and settlement of mobile calls

(75) Inventor: Steven Heap, Haymarket, VA (US)

Correspondence Address: Alfred W. Froebrich, Esq.;Cohen Pontani Lieberman & Pavane LLP, 551 Fifth Avenue, Suite 1210, New York, NY, 10176, US

(73) Assignee: Arbinet-thexchange, Inc.

(21) Appl. No.: 11/973,768

(22) Filed: Oct. 10, 2007

Related U.S. Application Data
(60) Provisional application No. 60/828,818, filed on Oct. 10, 2006.

(51) Int. Cl. H04Q 7/20

(52) U.S. Cl. 455/445

(57) ABSTRACT

A method of routing and settling a mobile call includes the steps of routing, by an originating carrier switch, signaling set-up messages for a mobile call to an operator switch. The mobile call is associated with one of a plurality of mobile carriers within a region. The operator switch receives the signaling set-up messages for the mobile call from the originating carrier and obtains information from the signaling set-up message. The information obtained includes the destination number of the call. The operator switch then queries a database to determine whether the destination number is ported, the database including a list of all telephone numbers ported within the region.

### CROSS-REFERENCE TO RELATED APPLICATIONS

The present invention claims priority to provisional application No. 60/828,818, filed on Oct. 10, 2006, the entire contents of which are incorporated herein by reference.

### BACKGROUND OF THE INVENTION

1. Field of the Invention

The present invention relates to routing and settlement of mobile calls with respect to ported telephone numbers.

2. Description of the Related Art

Telephone number portability is the ability to switch telephone service providers or carriers within the same geographic area and keep the same telephone number. When a number has been switched, the telephone number is referred to as a ported number. Both wireline and wireless phone numbers can be ported. In addition, a telephone number can be ported from a wireline carrier to a wireless carrier and vice versa.

When a call to a mobile phone transfers from an originating carrier to a receiving carrier, termination fees are customarily paid by the originating network to the receiving network. Various carriers charge different termination fees. Accordingly, if an originating carrier can not determine the receiving carrier, the originating party does not know the exact termination fee. Carriers typically own a number range and assign telephone numbers in that range to its customers. Thus, if a number has not been ported, the receiving carrier can be determined from the destination telephone number. However, the majority of carriers have no way of determining whether a mobile number has been ported. Similarly, an international carrier in the receiving or destination country may not know how much to charge for a termination when it does not know the mix of calls to the different mobile carriers in its country. Furthermore, many international carriers do not have the capability to query every call to determine whether a destination mobile number has been ported.

### SUMMARY OF THE INVENTION

An object of the present invention is to cost-effectively split call traffic into portability corrected streams to transparently and seamlessly exchange traffic between carriers without complex technical solutions or features.

This object is met by a method of routing and settling a mobile call, which includes the steps of routing, by an originating carrier switch, signaling set-up messages for a mobile call to an operator switch, the mobile call being associated with one of a plurality of mobile carriers within a region, receiving, by the operator switch, the signaling set-up messages for the mobile call from the originating carrier, obtaining information from the signaling set-up message, the information including the destination number of the call, and querying, by the operator switch, a database to determine whether the destination number is ported, the database including a list of all telephone numbers ported within the region. The region may, for example, comprise a country or other region.

If it is determined in the step of querying that the destination number is not ported, then the operator switch releases the call to the originating carrier switch and the originating carrier switch interconnects the call to a destination carrier of the destination number.

If it is determined in the step of querying that the destination number is ported, then determining a destination carrier associated with the destination number, and accepting, by the operator switch, the signaling set-up message.

According to an embodiment of the present invention, a plurality of trunk groups having a plurality of trunks is connected between the operator switch and another switch, each trunk group being assigned to a different one of the mobile carriers in the region. The call is routed by the operator switch using the one of the trunks in the trunk group that is associated with the destination carrier of the destination number. The other switch connected to the trunk group may be the originating carrier switch or a downstream switch. Furthermore, the originating carrier switch may be an international switch.

Instead of using a trunk group, the operator switch may simply route the call to one of the originating carrier switch or a downstream carrier switch with a prefix identifying the destination carrier associated with the destination number.

The operator switch may also generate invoices for the originating carrier and the downstream carrier each month, or other time period, based on a public or private billing rate. The operator switch may also generate a report of actual traffic. The generation of invoices and reports of actual traffic may be accomplished using an accounting module as disclosed in U.S. Pat. No. 6,731,729, the entire contents of which are incorporated herein by reference.

The database queried by the operator switch includes information regarding routing information for all ported telephone numbers within the region. The step of querying may include querying, by the operator switch, the database through a variety of different signaling methods.

The object of the present invention is also met by an operator switch connectable to one of a VoIP network and a telecommunications network. Switches in such networks are typically processor driven multiplexers that are programmed to route calls according to the carrier who owns the switch. Thus, the operator switch includes a memory storing a program comprising computer executable instructions for receiving call signaling from an originating carrier, extracting destination number information from the call signaling, and querying a database to determine whether the destination number is a ported telephone number.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a system diagram showing an overview of the connections between the various components;

FIG. 2 is a system diagram as in FIG. 1 showing the connections after the originating carrier signals the operator;

FIG. 3 is a system diagram as in FIG. 1 showing the connections when the destination number is not ported;

FIG. 4 is a system diagram as in FIG. 1 showing the connections when the destination number is ported;

FIG. 5 is a system diagram according to a further embodiment of the present invention; and

FIG. 6 is a flow diagram of the method according to the present invention.

### DETAILED DESCRIPTION OF THE PRESENTLY PREFERRED EMBODIMENTS

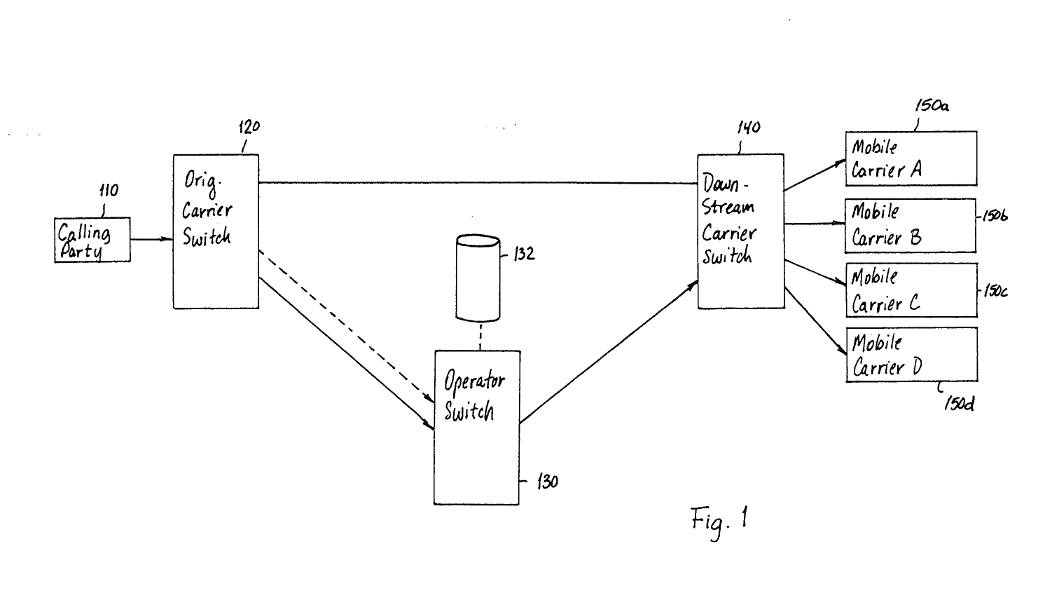

FIG. 1 is a schematic diagram showing the basic components of a system implementing the present invention. An originating telephone 110 is connected via a local and/or long distance network to an originating carrier switch 120. An operator switch 130 and downstream carrier switch 140 are connected to the originating carrier switch 120. The switches 120, 130, 140 may comprise routers or VoIP switches in a data network such as the Internet. Alternatively, the switches 120, 130, 140 may comprise telecommunication switches such as, for example, time division multiplexing (TDM) switches in a telecommunications network. The downstream carrier 140 is connected to a plurality of mobile carriers 150a, 150b, 150c, 150d. Although four mobile carriers are shown, any number of mobile carriers may be connected in accordance within the capacity of downstream carrier switch 140. A database 132 is connected to the operator switch 130. The database 132 may, for example, be arranged in or queried by a switch control point (SCP) of an intelligent network (IN) or may be queried directly by the operator switch 130. The information in the database is obtained from a national or regional database that tracks ported numbers. Such a database is maintained and administered for the US/Canadian system by the National Portability Administration Center (NPAC).

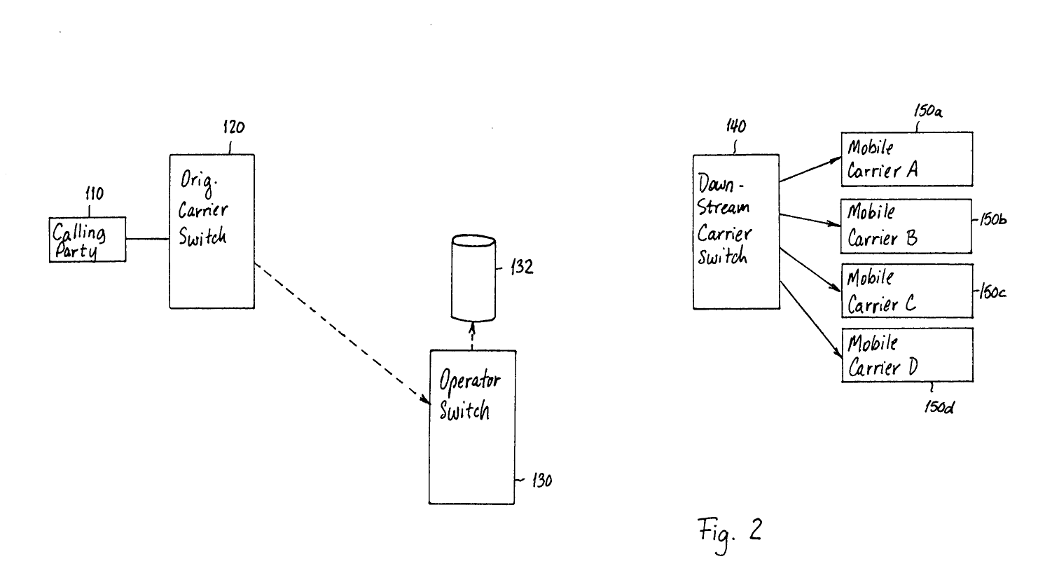

Referring to FIG. 2, the caller originates the call and the originating carrier switch 120 signals the call to the operator switch 130 by sending a set-up message 122. The originating carrier may route all mobile calls to the operator switch 130. Alternatively, the originating carrier may route all mobile calls of a certain type, i.e., all German mobile traffic, to the operator switch 130 and may route other types of mobile calls to other operators. The set-up message or signaling may comprise, but is not limited to, SS7, C7, SIP or H.323 signaling. Upon receipt of the set-up message 122, the operator switch 130 extracts information about the call from the set-up message and queries the database 132 to determine if the destination number has been ported.

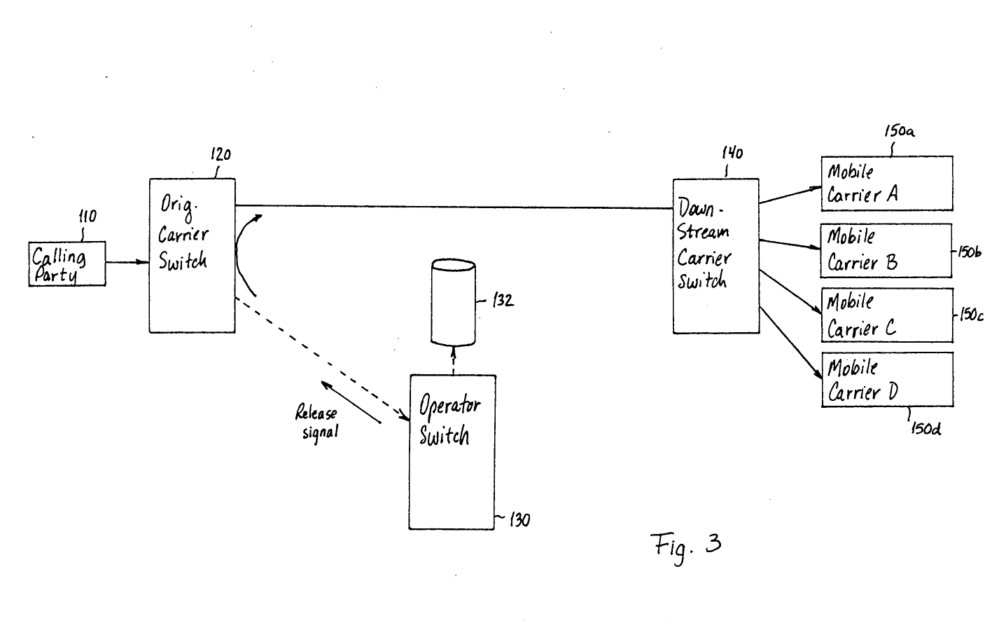

FIG. 3 shows the call flow when it is determined from the database 132 that the destination number is not ported. The operator switch 130 sends a release signal back to the originating carrier switch 120 which indicates to the originating carrier switch 120 that the call should advance directly to the downstream carrier 140 through a bilateral connection. The release signal sent to the originating carrier switch 120 may, for example, comprise a congestion release signal. Most calls should follow this route. Currently, 90-95% of calls are to non-ported numbers.

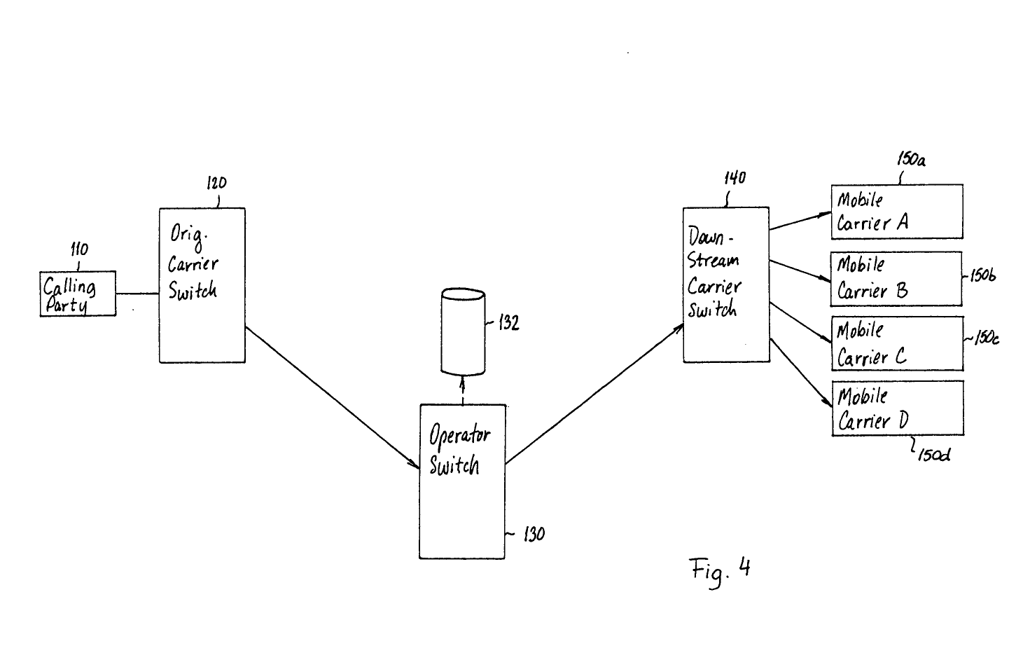

FIG. 4 shows the call flow when it is determined from the database 132 that the destination number is ported. In this case, the operator switch 130 accepts the call and the call is routed through the operator switch 130. Before advancing the call to the downstream carrier switch 140, the operator switch 130 adds a prefix identifying the new carrier of the destination phone number. Instead of advancing the call to the downstream carrier switch 140, the operator could route the call back to the originating carrier and allow the originating carrier to route the call to the new mobile carrier using the information from the prefix.

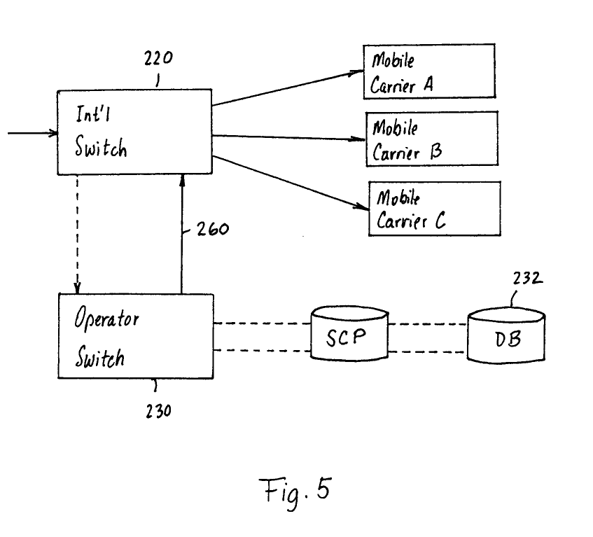

FIG. 5 shows a further embodiment in which an international gateway exchange or an international switch 220 signals all calls to mobile phones to an operator switch 230. The international switch 220 and operator switch 230 are similar to the switches described above and may comprise VoIP or TDM switches. As described above, the operator switch 230 queries a database 232 based on the call signaling data to determine if the destination telephone number is ported. If it is unported, a release signal is sent to the international switch and the international switch routes the call. A plurality of outgoing trunk groups 260 are created between the operator switch 230 and the international switch 220, each outgoing trunk group being associated with a respective one of the mobile carriers 250a, 250b, 250c and comprising at least one trunk. If it is determined that the destination number is ported, the operator switch 230 accepts the call and routes it to the international switch 220 using the trunk group associated with the correct destination carrier 250a, 250b, 250c. Thus, the international switch 230 would recognize the mobile carrier associated with the destination number based on which trunk group the operator switch 230 uses. The operator switch 230 may also add a prefix to the destination number so that all downstream switches recognize the correct carrier for the call.

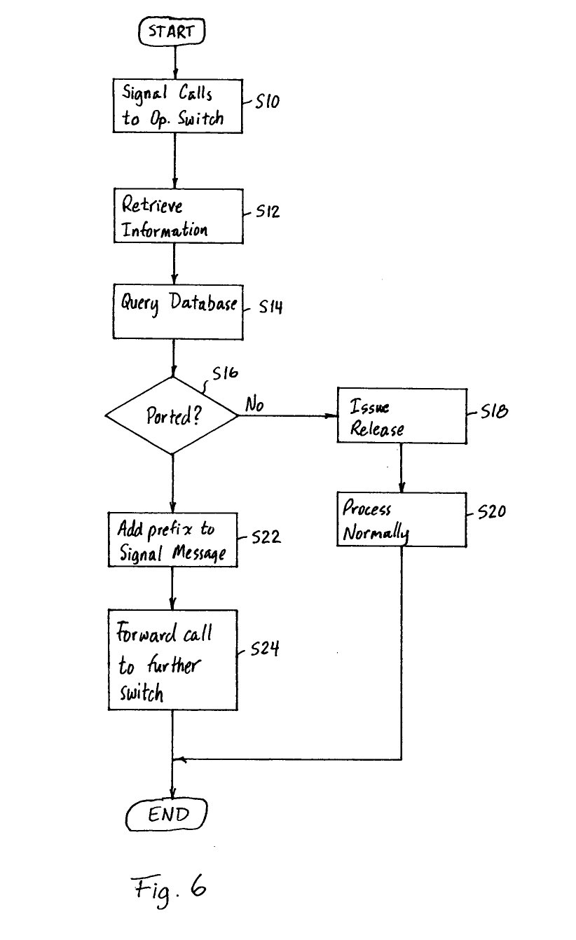

FIG. 6 is a flow diagram of the steps of the method according to the present invention. At step S10, an originating carrier switch 120, 220 signals all mobile calls to the operator switch 130. 230. As stated above, the call may comprise all mobile calls to mobile carriers within a region, i.e., within Germany. The operator switch retrieves information about the call from the call signaling, step S12. The operator switch queries a portability database 132, 232, step S14, and determines from the database whether the destination number is ported, step S16. If the destination number is not ported, the operator switch issues a “congestion” release to the originating carrier switch, step S18, and the originating carrier switch routes the call, S20. If the destination number is ported, a prefix is added to the destination number indicating the new carrier, step S22. The operator then forwards the call to the originating carrier switch or a downstream carrier switch with the prefix, step S24. As described above, this step may involve forwarding the call on a trunk of a trunk group associated with the destination carrier of the destination number.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of routing and settling a mobile call, comprising the steps of:
routing, by an originating carrier switch, signaling set-up messages for a mobile call to an operator switch, the mobile call being associated with one of a plurality of mobile carriers within a region;
receiving, by the operator switch, the signaling set-up messages for the mobile call from the originating carrier;
obtaining information from the signaling set-up message, the information including the destination number of the call; and
querying, by the operator switch, a database to determine whether the destination number is ported, the database including a list of all telephone numbers ported within the region.

2. The method of claim 1, wherein, if it is determined in said step of querying that the destination number is not ported, then releasing the call to the originating carrier switch and interconnecting, by the originating carrier switch, the call onto a destination carrier of the destination number.

3. The method of claim 1, wherein, if it is determined in said step of querying that the destination number is ported, then determining a destination carrier associated with the destination number, and accepting, by the operator switch, the signaling set-up message.

4. The method of claim 3, further comprising the step of providing a plurality of trunk groups having a plurality of trunks connected between the operator switch and another switch, each trunk group being assigned to a different one of the mobile carriers in the region.

5. The method of claim 4, further comprising the step of routing the call, by the operator switch, using the one of the trunks in the trunk group that is associated with the destination carrier of the destination number.

6. The method of claim 4, wherein the another switch is the originating carrier switch.

7. The method of claim 6, wherein the originating switch is an international switch.

8. The method of claim 3, further comprising the step of routing, by the operator switch, the call to one of the originating carrier switch or a downstream carrier with a prefix identifying the destination carrier associated with the destination number.

9. The method of claim 3, further comprising the step of generating, by the operator switch, invoices for the originating carrier and the downstream carrier based on a public or private billing rate.

10. The method of claim 3, further comprising the step of generating a report of actual traffic.

11. The method of claim 1, wherein said step of routing comprises routing all mobile calls for mobile carriers within a predetermined geographical boundary to the operator switch.

12. The method of claim 1, wherein the database includes information regarding routing information for all ported telephone numbers within the region.

13. The method of claim 1, wherein said step of querying includes querying, by the operator switch, the database through a service control point.

14. An operator switch connectable to one of a VoIP network and a telecommunications network, said operator switch comprising a memory storing a program comprising computer executable instructions for receiving call signaling from an originating carrier, extracting destination number information from the call signaling, and querying a database to determine whether the destination number is a ported telephone number.

15. The operator switch of claim 14, wherein the program further comprises computer executable steps of, if it is determined in said step of querying that the destination number is not ported, then releasing the call to the originating carrier switch and interconnecting, by the originating carrier switch, the call onto a destination carrier of the destination number

16. The operator switch of claim 14, wherein the program comprises computer-executable steps of, if it is determined in said step of querying that the destination number is ported, then determining a destination carrier associated with the destination number, and accepting, by the operator switch, the signaling set-up message.

17. The operator switch of claim 16, further comprising a plurality of trunk groups having a plurality of trunks connected between the operator switch and another switch, each trunk group being assigned to a different one of the mobile carriers in the region.

18. The operator switch of claim 17, wherein the program further comprises the step of routing the call, by the operator switch, using the one of the trunks in the trunk group that is associated with the destination carrier of the destination number.

19. The operator switch of claim 16, wherein the computer program comprises a computer executable step for routing, by the operator switch, the call to one of the originating carrier switch or a downstream carrier with a prefix identifying the destination carrier associated with the destination number.
